(19) United States
(12) Patent Application Publication
(10) Pub. No.: US 2020/0079881 A1
(43) Pub. Date: Mar. 12, 2020

(54) PROCESS FOR SURFACE TREATMENT OF SILICONE RUBBER ARTICLE

(71) Applicant: Pioneer Material Precision Tech Co., Ltd., New Taipei City (TW)

(72) Inventors: Jung-Hua Shen, New Taipei City (TW); Yi-Lun Chen, New Taipei City (TW)

(73) Assignee: Pioneer Material Precision Tech Co., Ltd., New Taipei City (TW)

(21) Appl. No.: 16/294,363

(22) Filed: Mar. 6, 2019

(30) Foreign Application Priority Data
Sep. 10, 2018 (TW) 107131675

(51) Int. Cl. C08C 19/38; C08C 19/04

(52) U.S. Cl. CPC C08C 19/38; C08C 19/04

(57) ABSTRACT

A process for surface treatment of a silicone rubber article includes the steps of:
(a) surface-treating the silicone rubber article with ultraviolet radiation to permit hydrogen groups on a surface of the silicone rubber article to be converted to hydroxyl groups; and
(b) subjecting the surface-treated silicone rubber article to another surface treatment with a poly(fluoroalkylene oxide) ether trialkoxy silane-based composition to permit a chemical reaction therebetween.

### CROSS-REFERENCE TO RELATED APPLICATION

This application claims priority of Taiwanese Application No. 107131675, filed on Sep. 10, 2018.

### FIELD

The disclosure relates to a process for surface treatment, and more particularly to a process for surface treatment of a silicone rubber article.

### BACKGROUND

Conventional silicone rubber articles usually caused problems such as undesirable touch feeling and the like, and are easily adhered with contaminants (for example, dusts, fibers, and the like). Therefore, they are not preferred to be used directly as articles that come into direct contact with human skin (such as bracelets and mobile phone protective shells) or as articles for invasive medical procedures (such as endoscopic tubes).

Current surface treatment methods for modifying the surfaces of the conventional silicone rubber articles include paint spraying, plasma treatment, chemical vapor deposition (CVD), and the like. However, the extent of improvement achieved by the current surface treatment methods is limited, and the thus modified silicone rubber articles usually have abrasion and peeling-off problems. In addition, usage of the current surface treatment methods is often accompanied by production of byproducts that are harmful to the environment (such as volatile organic compounds).

### SUMMARY

Therefore, an object of the disclosure is to provide a process for surface treatment of a silicone rubber article to overcome the aforesaid shortcomings of the prior art.

According to the disclosure, there is provided a process for surface treatment of a silicone rubber article, comprising the steps of:

(a) surface-treating the silicone rubber article with ultraviolet radiation to permit hydrogen groups on a surface of the silicone rubber article to be converted to hydroxyl groups; and

(b) subjecting the surface-treated silicone rubber article to another surface treatment with a poly(fluoroalkylene oxide) ether trialkoxy silane-based composition to permit a chemical reaction therebetween.

### BRIEF DESCRIPTION OF THE DRAWINGS

Other features and advantages of the disclosure will become apparent in the following detailed description of the embodiment(s) with reference to the accompanying drawings, of which:

FIG. 1 illustrates a photograph showing the extent of dust residues sticking on the test sample of Example 1;

FIG. 2 illustrates a photograph showing the extent of dust residues sticking on the test sample of Comparative Example 1;

FIG. 3 illustrates a photograph showing the extent of dust residues sticking on the test sample of Comparative Example 2; and

FIG. 4 illustrates photographs showing the extent of dust residues sticking on the test samples of Comparative Examples 3 to 5.

### DETAILED DESCRIPTION

A process for surface treatment of a silicone rubber article according to the disclosure comprises the steps of:

(a) surface-treating the silicone rubber article with ultraviolet radiation to permit hydrogen groups on a surface of the silicone rubber article to be converted to hydroxyl groups; and

(b) subjecting the surface-treated silicone rubber article to another surface treatment with a poly(fluoroalkylene oxide) ether trialkoxy silane-based composition to permit a chemical reaction therebetween.

In certain embodiments, step (b) is implemented by sub-steps of:

(b1) coating the poly(fluoroalkylene oxide) ether trialkoxy silane-based composition on the surface-treated silicone rubber article; and

(b2) subjecting the poly(fluoroalkylene oxide) ether trialkoxy silane-based composition to a hydrolysis reaction to permit the chemical reaction between the surface-treated silicone rubber article and the poly(fluoroalkylene oxide) ether trialkoxy silane-based composition.

In certain embodiments, the chemical reaction in step (b) is a condensation reaction. In certain embodiments, the condensation reaction is a dehydration reaction.

In certain embodiments, the ultraviolet radiation in step (a) has a wavelength ranging from 150 nm to 300 nm. In certain embodiments, the wavelength of the ultraviolet radiation is 172 nm.

In certain embodiments, the process for surface treatment of the silicone rubber article according to the disclosure further comprises a step of subjecting the surface-treated silicone rubber article after the another surface treatment in step (b), to a heating treatment.

In certain embodiments, the chemical reaction in step (b) permits formation of a transparent film on the silicone rubber article via chemical bonding of the transparent film to a surface of the silicone rubber article.

In certain embodiments, the hydrolysis reaction in sub-step (b2) is implemented in a moisture-containing atmosphere.

In certain embodiments, the transparent film is formed by a condensation reaction of the poly(fluoroalkylene oxide) ether trialkoxy silane-based composition.

Examples of the disclosure will be described hereinafter. It is to be understood that these examples are exemplary and explanatory and should not be construed as a limitation to the disclosure.

### EXAMPLE 1

A silicone rubber sheet having a dimension of 150 mm×75 mm×2 mm, (commercially available from Shin-Etsu Silicone Co. Ltd., with a model number of KE-971-U) was surface-treated by the following steps (a), (b), and (c).

Step (a) : the silicone rubber sheet was irradiated with ultra-violet (UV) light having a wavelength of 172 nm under a nitrogen atmosphere to permit hydrogen groups on a surface of the silicone rubber sheet to be converted to hydroxyl groups. A distance from an UV light tube to the surface of the silicone rubber sheet was 3 mm. The UV light tube had an irradiation intensity of 210 mW/cm². The UV light had an accumulated exposure energy of 1500 mJ/cm². A conveyer belt had a conveying speed of 1 m/min.

Step (b) : The thus irradiated silicone rubber sheet was dip-coated with a coating agent containing hexafluoropropylene oxide ether trimethoxysiliane (commercially available from 3M Company with a model number of Novec 2202), followed by a hydrolysis reaction of the coating agent in a moisture-containing atmosphere to permit a dehydration reaction between the coating agent and the thus irradiated silicone rubber sheet, and a dehydration reaction of the coating agent itself, so as to form a transparent film on the silicone rubber sheet via chemical bonding of the transparent film to the surface of the silicone rubber sheet.

Step (c) : The surface-treated silicone rubber sheet was heated in an oven at a temperature ranging from 120° C. to 150° C. for 30 minutes to evaporate solvent contained in the coating agent so as to obtain a test sample of Example 1.

### Comparative Example 1

A silicone rubber sheet without any surface treatment was used as a test sample of Comparative Example 1.

### Comparative Example 2:

A test sample of Comparative Example 2 was obtained according to the procedure of Example 1, except that only step (a) was implemented (i.e., steps (b) and (c) were omitted).

### Comparative Example 3

A test sample of Comparative Example 3 was obtained according to the procedure of Example 1, except that only steps (b) and (c) were implemented (i.e., step (a) was omitted).

### Comparative Example 4

A silicone rubber sheet having a dimension of 150 mm×75 mm×2 mm (commercially available from Shin-Etsu Silicone Co. Ltd. with a model number of KE-971-U) was treated with an air plasma having an energy of 600 W for 5 minutes, in a vacuum atmosphere of 0.5 mbar to obtain a test sample of Comparative Example 4.

### Comparative Example 5

A test sample of Comparative Example 5 was obtained according to the procedure of Example 1, except that step (a) was replaced with a treatment with an air plasma having an energy of 600 W for 5 minutes in a vacuum atmosphere of 0.5 mbar.

### Friction Coefficient Measurement:

A dynamic friction coefficient of each of the test samples of Example 1 and Comparative Examples 1 to 5 was measured using a testing machine (Manufacturer: Instron Corp.; Model No.: 5965). Each of the test samples was subjected to three measurements and an average thereof was taken. The results are shown in Table 1 below.

TABLE 1

| Test sample | Dynamic friction coefficient |
|---|---|
| Example 1 | 0.074 |
| Comparative Example 1 | 0.374 |
| Comparative Example 2 | 0.241 |
| Comparative Example 3 | 0.322 |
| Comparative Example 4 | 0.294 |
| Comparative Example 5 | 0.380 |

As shown in Table 1, the dynamic friction coefficient (0.074) of the test sample of Example 1 is significantly reduced by about 80% compared to that (0.374) of the test sample of Comparative Example 1, in which no surface treatment was implemented. In addition, the dynamic friction coefficient (0.074) of the test sample of Example 1 is significantly further reduced compared to that (from 0.241 to 0.380) of the test samples of each of Comparative Examples 2 to 5, in which the other surface treatments were implemented. It is demonstrated that smoothness of the silicone rubber sheet can be significantly enhanced by the process for surface treatment of a silicone rubber article according to this disclosure.

### Extent of Dust Residues:

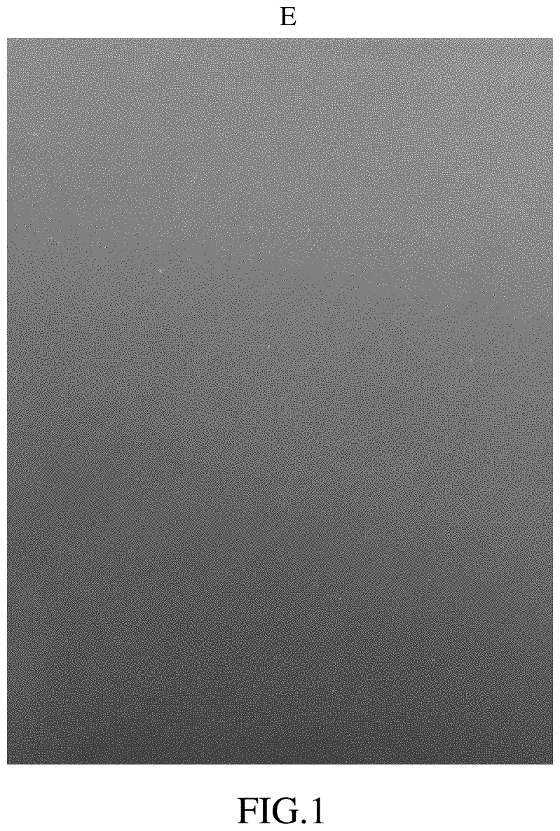

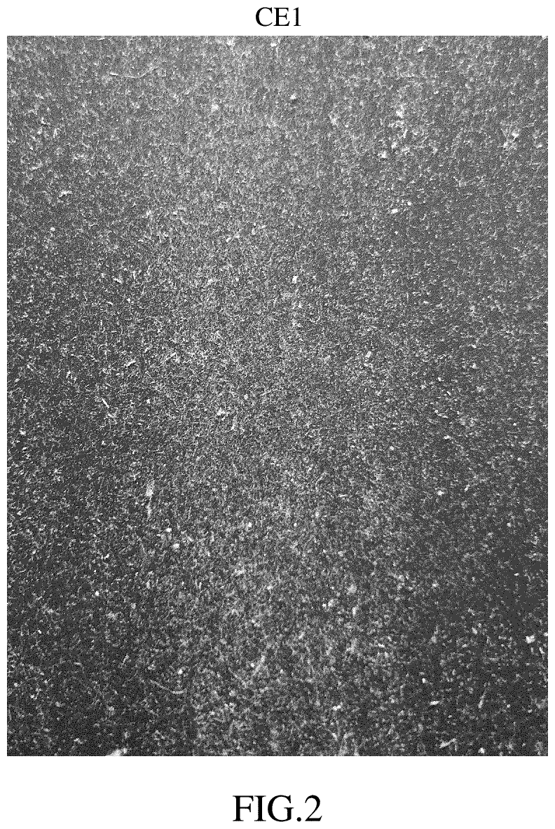

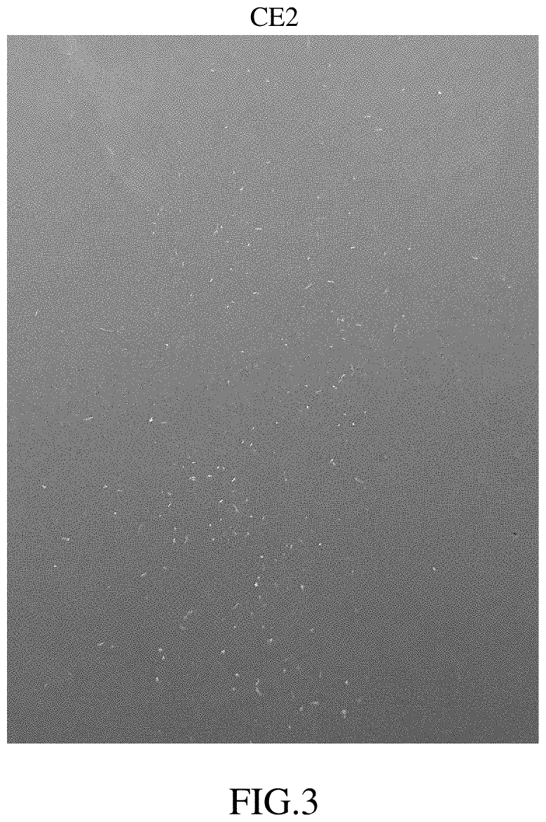

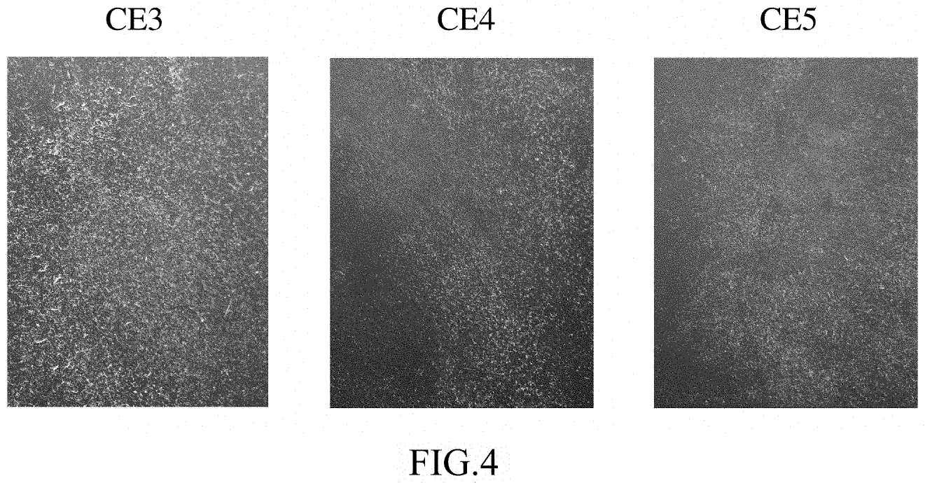

Each of the test samples of Example 1 and Comparative Examples 1 to 5 was wiped 20 times with a tissue paper, followed by photography thereof. The images are shown by FIGS. 1, 2, 3, and 4. An area ratio of tissue paper residues on each of the test samples was analyzed using Image J software. The results are shown in Table 2 below.

TABLE 2

| Test sample | Area ratio of tissue paper residues |
|---|---|
| Example 1 | 0.93% |
| Comparative Example 1 | 68.31% |
| Comparative Example 2 | 9.52% |
| Comparative Example 3 | 70.14% |
| Comparative Example 4 | 65.11% |
| Comparative Example 5 | 64.43% |

As shown by the images of FIGS. 1, 2, 3, and 4, and the results in Table 2, a significant amount of the tissue paper remained on the test sample of Comparative Example 1, and the area ratio of tissue paper residues on the test sample of Comparative Example 1 is 68.31%. There is a certain amount of the tissue paper that remained on the test piece of Comparative Example 2, and the area ratio of tissue paper residues on the test sample of Comparative Example 2 is 9.52%. A large amount of the tissue paper remained on each of the test samples of Comparative Examples 3 to 5, and the area ratio of tissue paper residues on the test samples of Comparative Examples 3 to 5 are 70.14%, 65.11%, and 64.43%, respectively. Contrary thereto, there was almost none of the tissue paper that remained on the test sample of Example 1, and the area ratio of tissue paper residues on the test sample of Example 1 is only 0.93%. That is, the area ratio of tissue paper residues on the test sample of Example 1 is reduced by 99% compared to that on the test sample of Comparative Example 1. It is demonstrated that the extent of dust sticking on the silicone rubber sheet can be significantly reduced by the process for surface treatment of a silicone rubber article according to the disclosure.

In view of the aforesaid, the smoothness of the silicone rubber article can be enhanced and the extent of dust sticking of the silicone rubber article can be significantly reduced by the process for surface treatment of a silicone rubber article according to the disclosure. In addition, since a transparent film is formed on the silicone rubber article via chemical bonding of the transparent film to a surface of the silicone rubber article, the abrasion and peeling-off problems encountered in the prior art can be avoided and an original appearance (for example, an original color) of the silicone rubber article can be maintained. Furthermore, the process for surface treatment of a silicone rubber article according to the disclosure does not produce byproducts that are harmful to the environment, such as volatile organic compounds, thereby overcoming the aforesaid shortcomings of the prior art.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A process for surface treatment of a silicone rubber article, comprising the steps of:
(a) surface-treating the silicone rubber article with ultraviolet radiation to permit hydrogen groups on a surface of the silicone rubber article to be converted to hydroxyl groups; and
(b) subjecting the surface-treated silicone rubber article to another surface treatment with a poly(fluoroalkylene oxide) ether trialkoxy silane-based composition to permit a chemical reaction therebetween.

2. The process according to claim 1, wherein step (b) is implemented by sub-steps of:
(b1) coating the poly(fluoroalkylene oxide) ether trialkoxy silane-based composition on the surface-treated silicone rubber article; and
(b2) subjecting the poly(fluoroalkylene oxide) ether trialkoxy silane-based composition to hydrolysis reaction to permit the chemical reaction between the surface-treated silicone rubber article and the poly(fluoroalkylene oxide) ether trialkoxy silane-based composition.

3. The process according to claim 2, wherein in step (b), the chemical reaction is a condensation reaction.

4. The process according to claim 3, wherein the condensation reaction is a dehydration reaction.

5. The process according to claim 1, wherein in step (a), the ultraviolet radiation has a wavelength ranging from 150 nm to 300 nm.

6. The process according to claim 5, wherein the wavelength of the ultraviolet radiation is 172 nm.

7. The process according to claim 1, further comprising a step of subjecting the surface-treated silicone rubber article after the another surface treatment in step (b), to a heating treatment.

8. The process according to claim 1, wherein in step (b), the chemical reaction permits formation of a transparent film on the silicone rubber article via chemical bonding of the transparent film to a surface of the silicone rubber article.

9. The process according to claim 2, wherein in sub-step (b2), the hydrolysis reaction is implemented in a moisture-containing atmosphere.

10. The process according to claim 8, wherein the transparent film is formed by a condensation reaction of the poly(fluoroalkylene oxide) ether trialkoxy silane-based composition.
